(19) United States
(12) Patent Application Publication
(10) Pub. No.: US 2002/0175142 A1
(43) Pub. Date: Nov. 28, 2002

(54) Method of forming capacitor element

(75) Inventor: Yukihiko Maejima, Tokyo (JP)

Correspondence Address: Patent Group, Hutchins, Wheeler & Dittmar, 101 Federal Street, Boston, MA, 02110, US

(73) Assignee: NEC Corporation

(21) Appl. No.: 10/098,302

(22) Filed: Mar. 15, 2002

(30) Foreign Application Priority Data
Mar. 16, 2001 (JP) 2001-075500

(51) Int. Cl. H01G 4/00

(52) U.S. Cl. 216/6; 216/41; 216/51; 216/76; 216/79

(57) ABSTRACT

A method of forming a capacitor element is provided. After the barrier layer is formed on the dielectric layer, the lower electrode layer, the ferroelectric layer, and the upper electrode layer are formed on the barrier layer in this order. Thereafter, the etching mask having a pattern for a desired capacitor element is formed on the upper electrode layer. Using the etching mask, the upper electrode layer, the ferroelectric layer, the lower electric layer, and the barrier layer are selectively removed by dry etching. The etching gas containing fluorine (F) as one of its constituent elements is used in the step of selectively removing the barrier layer. The mask layer is etched back by an etching action in the same step, thereby eliminating the mask layer. The aspect ratio of the contact hole that exposes the upper capacitor electrode can be decreased by the thickness of the remaining mask layer. Therefore, a desired capacitor element can be formed by using a process (e.g., the DC sputtering process) having a less step coverage or less hole-filling property. This means that a fine capacitor element with a ferroelectric material as the capacitor dielectric can be realized.

### BACKGROUND OF THE INVENTION

1. Field of the Invention

The present invention relates to a method of forming a capacitor element having a thin ferroelectric layer as its dielectric. More particularly, the invention is preferably applicable to the formation of a capacitor element used for memory cells of the so-called Ferroelectric Random-Access Memories (FeRAMs or FRAMs.) However, the invention is applicable to any other capacitor elements if it comprises a ferroelectric layer.

2 Description of the Related Art

In recent years, FeRAMs or FRAMs, which provide approximately the same function as the popular Dynamic Random-Access Memories (DRAMs) using semiconductor, have been drawing our attention as one of the new information storage devices. This is because FeRAMs are capable of large-scale integration, high-speed access, and nonvolatile information storage.

The basic structure of FeRAMs is the same as the ordinary DRAMs. Specifically, information is electrically written into memory cells arranged in a matrix array and the information is electrically read out from the memory cells. Each of the memory cells comprises a Metal-Oxide-Semiconductor Field-Effect Transistor (MOSFET) and a capacitor element. One of the two electrodes of the capacitor element is electrically connected to one of the pair of source/drain regions of a corresponding one of the MOSFETs. The other electrode of the element for the same MOSFET is commonly used for all the cells. Binary-coded information (i.e., 0 or 1) is stored by using the positive and negative residual polarization of the ferroelectric layer sandwiched by the pair of the electrodes of each element.

As the ferroelectric material for the ferroelectric layer, Pb(Zr₁₋ₓ, Tiₓ)O₃ (i.e., PZT) or the like is typically used. As the conductive material for the electrodes, noble metal such as platinum (Pt), iridium (Ir), and ruthenium (Ru) is typically used.

On the other hand, some of the conventional DRAMs with the integration scale of 4 gigabits (Gb) or greater comprise ferroelectric layers in the capacitor elements of the memory cells, with the DRAMs of this type, (BaₓSr₁₋ₓ)TiO₃ or the like is typically used as the ferroelectric material and noble metal such as Pt, Ir, and Ru is used as the electrode material.

Next, the prior-art method of forming the capacitor element with the above-described structure is explained below in detail.

Generally, the capacitor element of this type comprises the three-layer structure of the lower electrode, the ferroelectric, and the upper electrode stacked in this order. The capacitor elements are formed on the semiconductor substrate along with MOSFETs. In this case, to selectively remove the lower electrode, the ferroelectric, and the upper electrode to have a desired pattern, a dry etching method is usually used with a specific mask.

To form the fine or miniaturized capacitor elements, the stacked layers for the lower electrode, the ferroelectric, and the upper electrode are selectively removed by dry etching processes using a single, common mask. The mask used for this purpose is divided into two types, the popular “resist mask” made of a patterned photoresist film, and the “hard mask” made of a patterned hard layer such as a SiO₂ layer.

When Ru is used for the upper and lower electrodes, it is effective to use a mixture of oxygen gas (O₂) and chlorine gas (Cl₂) as the etching gas for making fine patterns on the electrodes, as disclosed in the Japanese Non-Examined Patent Publication No. 8-78396 published in 1996. With this method, however desired etch rate ratio (i.e., etch selectivity) is unable to be realized between the Ru layer and the resist mask, in other words, the resist mask will disappear during the dry etching process. Thus, it is unavoidable to use the “hard mask” instead of the “resist mask”. In particular, a patterned SiO₂ layer is effectively used as the “hard mask”.

Subsequently, a prior-art method or forming a capacitor element using the known technique disclosed by the Japanese Non-Examined Patent Publication No 8-78396 is explained below with reference to FIGS. 1A to 1J. In this method, the upper and lower electrodes of the capacitor element of each memory cell are made of Ru while the ferroelectric thereof is made of PZT. A patterned SiO₂ layer is used as the hard mask.

First, the structure shown in FIG. 1A is formed. In this structure, as shown in FIG. 1A, a silicon (Si) substrate 101 is provided. The substrate 101 has a source/drain region 102 of a MOSFET (not shown) of a memory cell formed in its surface area. A thick interlayer dielectric layer 104 is formed on the substrate 101 to cover the source/drain region 102. A contact plug 103 made of tungsten (W) is formed to penetrate vertically the layer 104. The bottom end of the plug 103 is contacted with the region 102. A desired capacitor element is formed on the layer 104.

A titanium (Ti) layer 105, a titanium nitride (TiN) layer 106, a Ru layer 107, a PZT layer 108, and a Ru layer 109 are formed to be stacked in this order on the interlayer dielectric layer 104. The Ti layer 105 in the lowest level of the structure is contacted with the top end of the plug 103.

The Ru layer 107, the PZT layer 108, and the Ru layer 109 serve as the lower capacitor electrode, the ferroelectric, and the upper capacitor electrode, respectively. The TiN layer 106 and the Ti layer 105 have a function of enhancing the adhesion between the Ru layer 107 and the interlayer dielectric layer 104, and a function of preventing the diffusion of the oxygen (O) and lead (Pb) atoms from the PZT layer 108 into the layer 104 (i.e., serve as a diffusion barrier against the O and Pb atoms).

Next, as shown in FIG. 1B, a SiO₂ layer 110 (which is used as a hard mask) is formed on the RU layer 109 in the uppermost level and patterned to have a desired shape of the capacitor element. At this stage, the thickness of the SiO₂ layer 110 is set in such a way as to sufficiently withstand the dry etching process to be carried out later. In other words, the thickness of the layer 110 needs to be set in such a way that the layer 110 is left at a sufficient thickness value at the end of the dry etching processes. For example, if the Ru layer 109 is 100 nm in thickness, the PZT layer 108 is 200 nm in thickness, the Ru layer 107 is 100 nm in thickness, the TiN layer 106 is 50 nm in thickness, and the Ti layer 105 is 20 nm in thickness, the SiO₂ layer 110 needs to have a thickness of approximately 500 nm.

Subsequently, as shown in FIG. 1C, the Ru layer 109 for the upper capacitor electrode is selectively removed by a dry etching process using the patterned SiO₂layer 110 as a mask. In this process, the gaseous mixture of O₂ and Cl₂ is used as the etching gas, like the above-described Publication No. 8-7899.

Using the same patterned SiO₂ layer 110 as a mask, the PZT layer 108 for the capacitor dielectric is selectively removed by a dry etching process, as shown in FIG. 1D. In this process, for example, the gaseous mixture of CF₄ and O₂ is preferably used as the etching gas, because it makes it possible to provide a comparatively large etch-rate ratio or etch selectivity between the PZT and SiO₂ layers 108 and 110.

Using the same patterned SiO₂ layer 110 as a mask, the Ru layer 107 for the lower capacitor electrode is selectively removed by a dry etching process, as shown in FIG. 1E. In this process, the gaseous mixture of O₂ and Cl₂ is preferably used as the etching gas, like the process of etching the Ru layer 109 for the upper capacitor electrode.

Using the same patterned SiO₂ layer 110 as a mask, the TiN layer 106 and the Ti layer 105 are selectively and successively removed by a dry etching process, as shown in FIG. 1F. In this process, gaseous Cl₂ or the gaseous mixture of Cl₂ and BCl₂ is preferably used as the etching gas.

The etching gas and the etch rate ratio (i.e., etch selectivity) of the above-described dry etching processes for the layers 109, 108, 107, 106, and 105 are shown in Table 1 below.

TABLE 1

| | | ETCH-RATE RATIO |
|---|---|---|
| LAYER TO BE ETCHED | ETCHING GAS | TO SiO₂ |
| Ru layer 109 | Cl₂ + O₂ | 5 |
| (Upper Electrode) | | |
| PZT layer 108 | CF₄ + O₂ | 1 |
| (Dielectric) | | |
| Ru layer 107 | Cl₂ + O₂ | 5 |
| (Lower Electrode) | | |
| TiN layer 106 | Cl₂ + BCl₃ | 1 |
| Ti layer 105 | | |
| (Diffusion Barrier) | | |

Through the above-described dry etching process, as shown in FIG. 1G, a stacked structure 120 of the patterned Ru layer 109, the patterned PZT layer 108, the patterned Ru layer 107, the patterned TiN layer 106, and the patterned Ti layer 105 is formed on the interlayer dielectric layer 104 made of SiO₂. The Ru layer 109, the PZT layer 108, and the Ru layer 107 in the structure 120 constitute the desired capacitor element for the memory cell. At this stage, the patterned SiO₂ layer 110 serving as the hard mask is left on the Ru layer 109 in the uppermost level.

In the state of FIG. 1G, the initial thickness of approximately 500 nm of the SiO₂ layer 110 is has been decreased to approximately 200 nm in the middle of the layer 110. The thickness of the layer 110 has been decreased in its peripheral area (i.e., tapered), as seen from FIG. 1G.

If the initial thickness of the SiO₂ layer 110 is less than approximately 500 nm, the thickness of the layer 110 is decreased to be less than approximately 200 mm in the middle of the layer 110 at the end of the dry etching processes. At the same time, the layer 110 is eliminated in its peripheral area, thereby exposing the underlying Ru layer 109 from the layer 110. In this state, the underlying Ru layer 109 is likely to be etched by the Cl₂-based etching gas, though the etch rate is small. Thus, the Ru layer 109 will be in a tapered shape like the layer 110, which means that the layer 109 is unable to have a desired shape. As a result, it is not preferred that the initial thickness of the SiO₂ layer 110 is set at a value less than approximately 500 nm.

Subsequently, as shown in FIG. 1H, a SiO₂ layer 111 (which serves as a cover layer of the capacitor element) is formed to cover the whole surface of the substrate 101 while the SiO₂ layer 110 is not removed. The thickness of the SiO₂ layer 111 is approximately 500 nm.

The SiO₂ layer 111 (i.e., the cover layer) and the SiO₂ layer 110 (i.e. , the mask) are selectively removed by a dry etching process, thereby forming a contact hole 112 penetrating vertically the layers 111 and 110, as shown in FIG. 1I. The hole 112 exposes the Ru layer 109 for the upper electrode.

Finally, as shown in FIG. 1J, an aluminum (Al) layer 113 for wiring is formed on. the SiO₂ layer 111 to contact the Ru layer 109 by way of the hole 112.

The size (or diameter) of the contact hole 112 varies according to the size of the capacitor element. For example, the capacitor element is designed for a highly integrated FeRAM, the size of the element (which is equal to the size of the upper capacitor electrode) needs to be 1 μm or less. In this case, the size (or diameter) of the contact hole 112 needs to be 0.4 μm or less.

The above-described prior-art method of forming a capacitor element shown in FIGS. 1A to 1J has the following problem.

In the above-described prior-art method, the patterned SiO₂ layer 110 is used as the hard mask for the dry etching processes. This is mainly because the upper and lower capacitor electrodes are respectively formed by the Ru layers 109 and 107 and thus, the mixture of Cl₂ and O₂ gases needs to be used as the etching gas. Any resist mask is unable to be used if the mixture of Cl₂ and O₂ gases is used for etching.

On the other hand, the capacitor element or the stacked structure 120 is formed and then, the SiO₂ layer 111 is additionally formed to cover the structure 120 as the cover layer. Thus, the total thickness of the SiO₂ layers 110 and 111 is approximately 700 nm on the upper electrode layer 109.

As described above, for example, if the capacitor element or the structure 120 is 1 μm or less in size, the size (or diameter) of the contact hole 112 needs to be 0.4 μm or less. Therefore, the hole 112 will have an aspect ratio as high as approximately 1.75.

With the fabrication processes of the ordinary Large-Scale Integrated circuits (LSIs) such as DRAMs, for example, a tungsten (W) layer formed by the CVD (Chemical Vapor Deposition) method (i.e., a CVD-W layer) is used to form an Al wiring line to cover a contact hole with a large aspect ratio. In this case, the W layer can be formed to fill the contact hole and thus, the upper electrode of the capacitor element is electrically connected to the Al wiring line by way of the part of the W layer in the hole. Moreover, the use of the CVD-W layer makes it possible to cope easily with the hole 112 with the aspect ratio of approximately 1.75. In the CVD process of forming the W layer, the gaseous mixture of WF₆ and H_{z} or the like is used as the reaction gas.

However, with the capacitor element designed for the FeRAM, the use of the CVD-W layer is unable to be used. This is because H₂ gas used in the CVD process will reduce the ferroelectric material such as PZT to thereby degrade its ferroelectric characteristics. Due to degradation of the ferroelectric characteristics of the ferroelectric material, the residual polarization and/or the dielectric resistance of the ferroelectric material decreases and as a result, the desired memory cell operation becomes impossible.

Essentially, the CVD process is a process to deposit metal as one of the constituent elements of the reaction gas by reducing the same. Therefore, it is unavoidable that the ferroelectric material is reduced simultaneously in the CVD process.

Accordingly, to form a wiring line or layer over the capacitor element, a process that occurs no reduction reaction, for example the DC sputtering process, is used. However, the DC sputtering process has a much lower step coverage or hole-filling property than the CVD process for forming the W layer and thus, it is unable to be applied to the contact hole with a high aspect ratio. In other words, the DC sputtering process is applicable when the size of the capacitor element is large and at the same time, the size of the contact hole is large as well. On the other hand, it is unable to be applied when the size of the capacitor element is as small as 1 μm or less and at the same time, the aspect ratio of the contact hole is equal to 1.5 or higher.

In summary, the above-described prior-art method is unable to be applied to the formation of fine or miniaturized capacitor elements.

### SUMMARY OF THE INVENTION

The invention was created to solve the above-described problem of the above-described prior-art method of forming a capacitor element.

Accordingly, an object of the present invention is to provide a method of forming a capacitor element that realizes a fine capacitor element with a ferroelectric material as the capacitor dielectric.

Another object of the present invention is to provide a method of forming a capacitor element that decreases the aspect ratio of the contact hole exposing the upper capacitor electrode.

Still another object of the present invention is to provide a method of forming a capacitor element that makes it possible to form a capacitor element using a process (e.g., the DC sputtering process) having a less step coverage or less hole-filling property.

The above objects together with others not specifically mentioned will become clear to those skilled in the art from the following description.

A method of forming a capacitor element according to the invention comprises the steps of:

(a) forming a barrier layer on a dielectric layer;

(b) forming a lower electrode layer, a ferroelectric layer, and an upper electrode layer in this order on the barrier layer;

(c) forming an etching mask having a pattern for a desired capacitor element on the upper electrode layer;

(d) selectively removing the upper electrode layer by dry etching using the mask;

(e) selectively removing the ferroelectric layer by dry etching using the mask;

(f) selectively removing the lower electrode layer by dry etching using the mask; and

(g) selectively removing the barrier layer by dry etching using the mask;

wherein an etching gas containing fluorine (F) as one of its constituent elements is used in the step (g);

and wherein the mask is etched back by an etching action in the step (g), thereby eliminating or removing the mask

With the method of forming a capacitor element according to the invention, after the barrier layer is formed on the dielectric layer, the lower electrode layer, the ferroelectric layer, and the upper electrode layer are formed on the barrier layer in this order. Thereafter, the etching mask having a pattern for a desired capacitor element is formed on the upper electrode layer. Using the etching mask, the upper electrode layer, the ferroelectric layer, the lower electric layer, and the barrier layer are selectively and successively removed by dry etching.

The etching gas containing fluorine (F) as one of its constituent element is used in the step (g) of selectively removing the barrier layer. The mask is etched back by an etching action in the same step (g), thereby eliminating or removing the mask.

Accordingly, the aspect ratio of the contact hole that exposes the upper capacitor electrode can be decreased by the thickness of the remaining mask in the prior-art method. Therefore, a desired capacitor element can be formed by using a process (e.g., the DC sputtering process) having a less step coverage or less hole-filling property and no capacitor-degradation property. This means that a fine capacitor element with a ferroelectric material as the capacitor dielectric can be realized.

In the method according to the invention, any dry etching process may be used. However, the plasma-enhanced etching process disclosed in the above-described Japanese Non-Examined Patent-Publication No. 8-78396 is preferably used.

The barrier layer may be a single layer or of a multi-layer structure. In the latter case, each of the sublayers that form the barrier layer may be made of the same material or different materials.

In a preferred embodiment of the method according to the invention, the etching mask is made of one selected from the group consisting of SiO₂, SiO, SiN, SiON, TiN, and TiO₂.

In another preferred embodiment of the method according to the invention, the barrier layer is made of at least one selected from the group consisting of Ti, compounds of Ti, Ta, and compounds of Ta.

In still another preferred embodiment of the method according to the invention, each of the lower electrode layer and the upper electrode layer contains at least one selected from the group consisting of Ru, RuO₂, Ir, IrO₂, Pt, and SrRuO₃.

In a further preferred embodiment of the method according to the invention, the ferroelectric layer contains one selected from the group consisting of Pb(Zr₁₋ₓ, Tiₓ)O₃, SrBi_{z}Ta_{z}O₃, and (BaₓSr₁₋ₓ) TiO₃.

In a still further preferred embodiment of the method according to the invention, the etching gas used in the step (g) is one selected from the group consisting of CF₄, CHF₃, C₄Fₐ, and C₅F₈.

It is preferred that the dielectric layer located below the barrier layer comprises a conductive plug, the plug having a top end contacted with the barrier layer.

### BRIEF DESCRIPTION OF THE DRAWINGS

In order that the present invention may be readily carried into effect, it will now be described with reference to the accompanying drawings.

FIGS. 1A to 1J are schematic, partial cross-sectional views showing a prior-art method of forming a capacitor element, respectively.

FIGS. 2A to 2J are schematic, partial cross-sectional views showing a method of forming a capacitor element according to an embodiment of the invention, respectively.

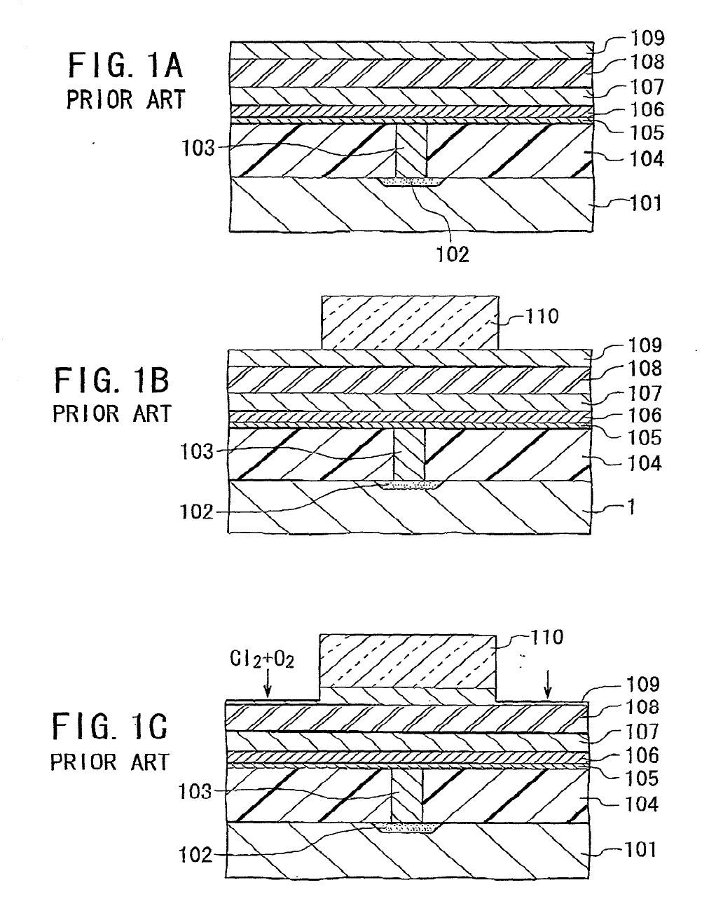

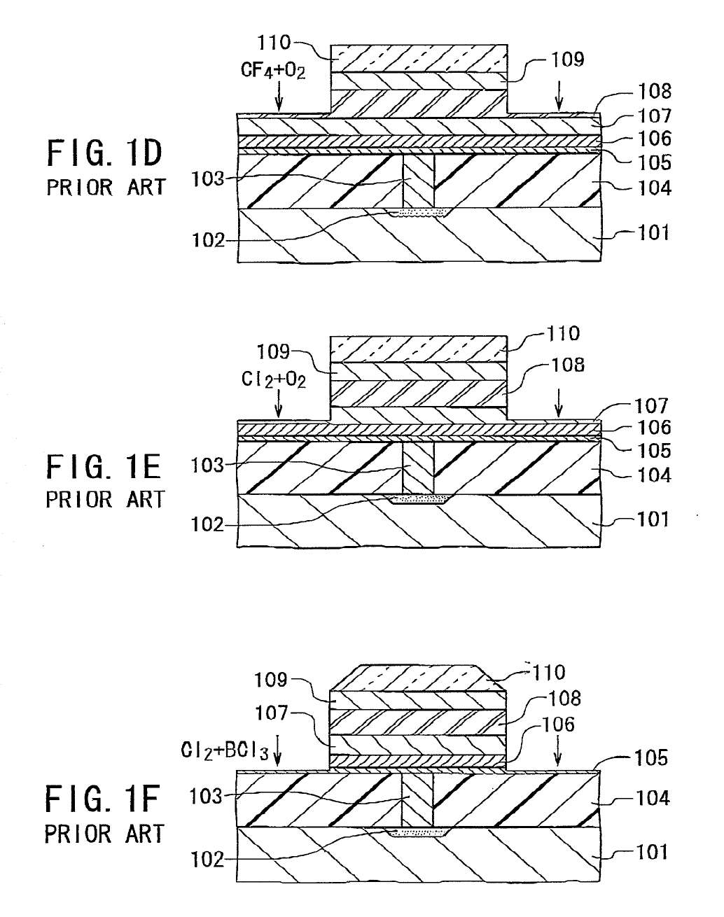

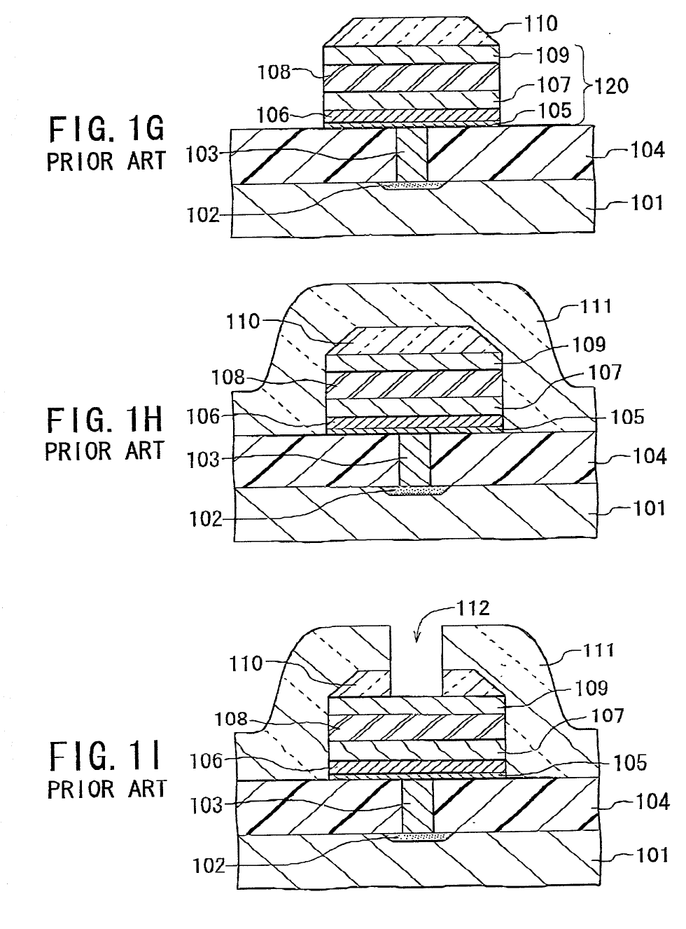

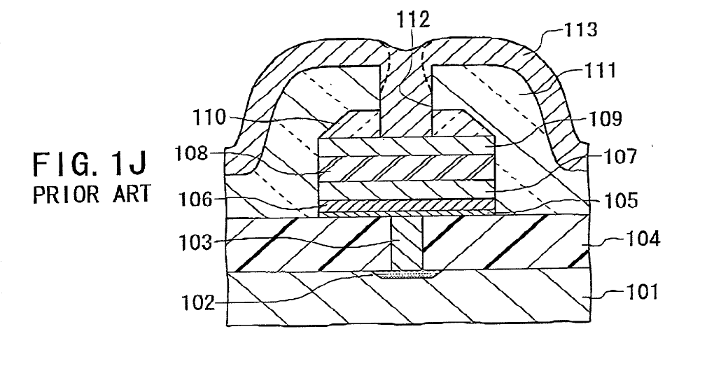

### DETAILED DESCRIPTION OF THE PREFERRED EMBODIMENTS

Preferred embodiments of the present invention will be described in detail below while referring to the drawings attached.

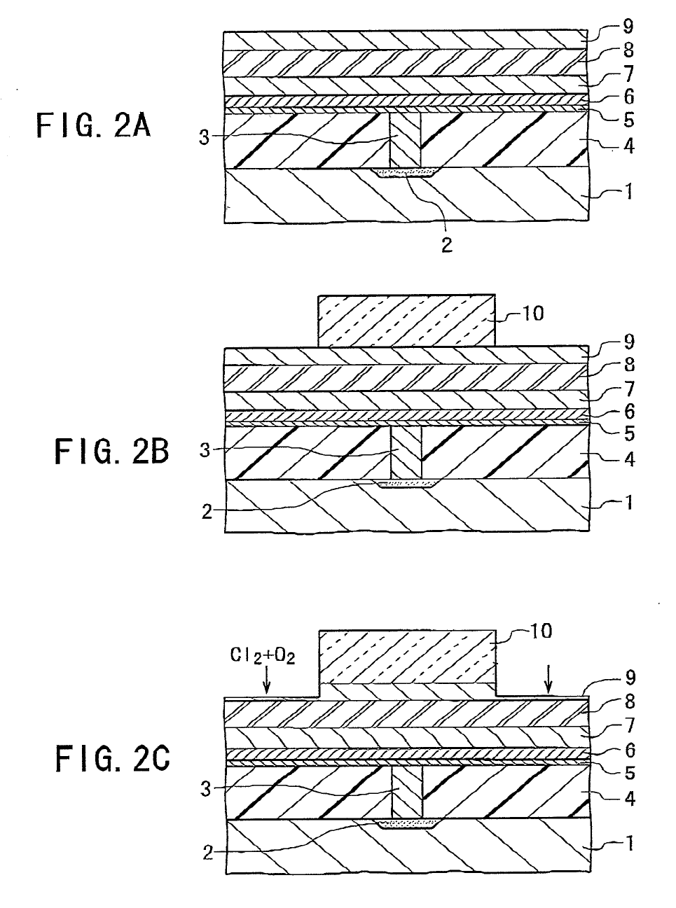

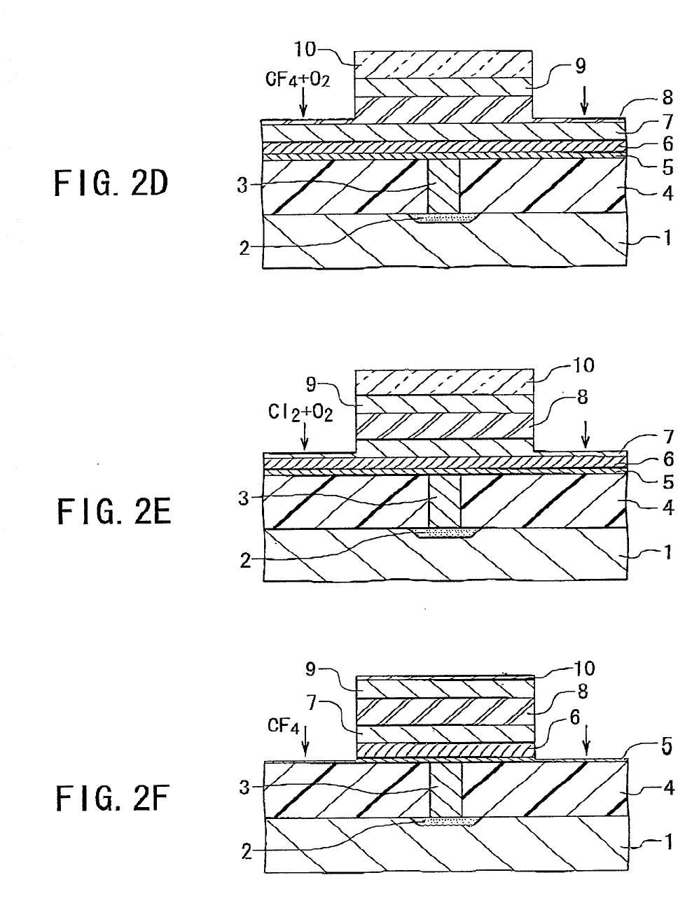

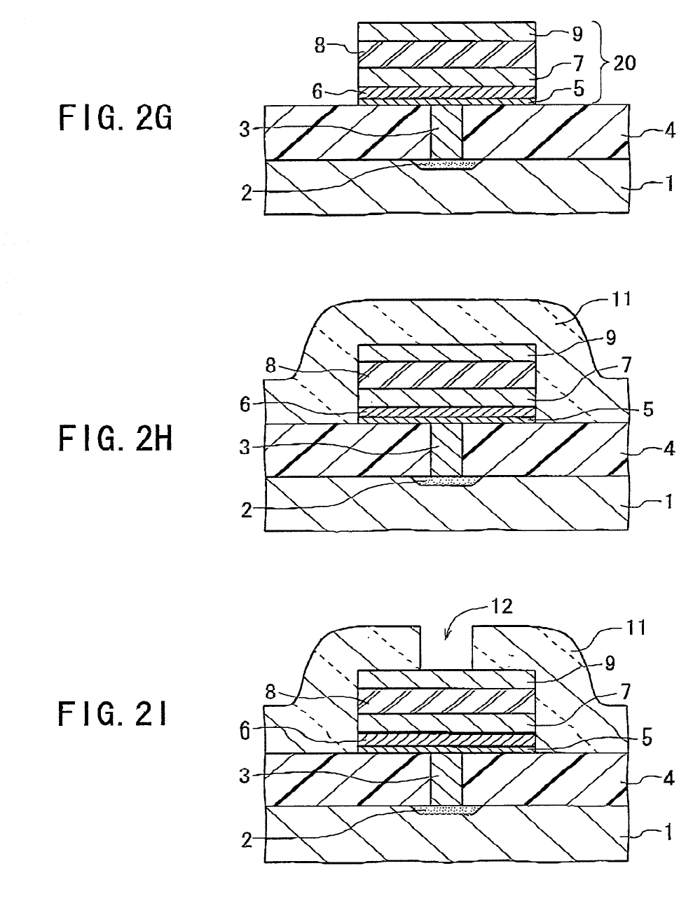

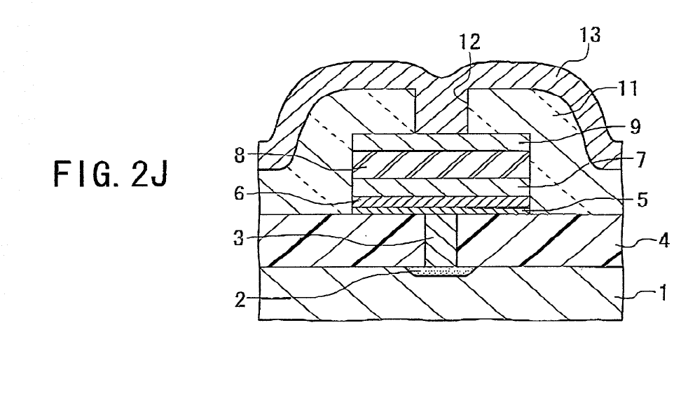

A method of forming a capacitor element according to an embodiment of the invention is explained below with reference to FIGS. 2A to 2J. In this method, the upper and lower electrodes of the capacitor element of each memory cell are made of Ru while the ferroelectric layer thereof is made of PZT. A patterned SiO₂ layer is used as the hard mask.

First, the structure shown in FIG. 2A is formed. In this structure, as shown in FIG. 2A, a Si substrate 1 is provided. The substrate 1 has a source/drain region 2 of a MOSFET (not shown) of a memory cell formed in its surface area. A thick interlayer dielectric layer 4 is formed on the substrate 1 to cover the source/drain region 2. A contact plug 3 made of W is formed in the layer 4 to penetrate vertically the layer 4. The bottom end of the plug 3 is contacted with the region 2. A desired capacitor element is formed on the layer 4.

A Ti layer 5 (thickness: 20 nm), a TiN layer 6 (thickness: 50 nm), a Ru layer 7 (thickness: 100 nm), a PZT layer 6 (thickness: 200 nm), and a Ru layer 9 (thickness: 100 nm) are formed to be stacked in this order on the interlayer dielectric layer 4. The Ti layer 5 in the lowest level of the structure is contacted with the top end of the plug 3.

The Ru layer 7, the PZT layer 6, and the Ru layer 9 serve as the lower capacitor electrode, the ferroelectric, and the upper capacitor electrode, respectively. The TiN layer 6 and the Ti layer 5 have a function of enhancing the adhesion between the Ru layer 7 and the interlayer dielectric layer 4, and a function of preventing the diffusion of the O and Pb atoms from the PZT layer 8 into the layer 4 (i.e., serve as a diffusion barrier against the O and Pb atoms).

Next, as shown in FIG. 2B, a SiO₂ layer 10 (thickness: 400 nm) (which is used as a hard mask) is formed on the Ru layer 9 in the uppermost level and patterned to have a desired shape of the capacitor element. At this stage, the thickness of the SiO₂ layer 10 is set in such a way as to sufficiently withstand the dry etching processes to be carried out later. In other words, the thickness of the layer 10 needs to be set in such a way that the layer 10 is left at a sufficient thickness value in the end of these dry etching processes. Although the thickness of the layer 10 may be greater then 400 nm, it is preferably set at an optimum value according to the total thickness of the layers to be etched. The optimum value varies dependent on the total thickness of the layers to be etched.

Subsequently, as shown in FIG. 2C, the Ru layer 9 for the upper capacitor electrode is selectively removed by a dry etching process using the patterned SiO₂ layer 10 mask. In this process, a known plasma-enhanced etching apparatus is used. The same etching conditions as disclosed in the above-described Japanese Non-Examined Patent Publication No. 8-78396 is applied to this process. The gaseous mixture of O₂ and Cl₂ is used as the etching gas, like the Publication No. 8-78396. In this etching process, the etch rate ratio (i.e., the etch selectivity) of the Ru layer 9 to the SiO₂ layer 10 is approximately 5 and therefore, the remaining thickness of the SiO₂ layer 10 will be approximately 380 nm when this etching process for the layer 3 is completed.

Using the same patterned SiO₂ layer 10 as a mask, the PZT layer 8 for the capacitor dielectric is selectively removed by a dry etching process with the same plasma-enhanced etching apparatus, as shown in FIG. 2D. In this process, the gaseous mixture of CF₄ and O₂ is preferably used as the etching gas, because it makes it possible to provide a comparatively large etch-rate ratio between the PZT and SiO₂ layers 8 and 10. Any other etching gas may be used for this purpose if a comparatively large etch-rate ratio between the PZT and SiO₂ layers 8 and 10 is obtainable. In this etching process, the etch-rate ratio of the PZT layer 8 to the SiO₂ layer 10 is approximately 1 and therefore, the remaining thickness of the layer 10 will be approximately 180 nm when this etching process for the layer 8 is completed.

Using the same patterned SiO₂ layer 10 as a mask, the Ru layer 7 for the lower capacitor electrode is selectively removed by a dry etching process with the same plasma-enhanced etching apparatus, as shown in FIG. 2E. In this process, the gaseous mixture of O₂ and Cl₂ is preferably used as the etching gas, like the process of etching the Ru layer 9 for the upper capacitor electrode. In this etching process, the etch rate ratio of the Ru layer 7 to the SiO₂ layer 10 is approximately 5 and therefore, the remaining thickness of the layer 10 will be approximately 160 nm when this etching process for the layer 7 is completed.

Using the same patterned SiO₂ layer 10 as a mask, the TiN layer 6 and the Ti layer 5 are selectively and successively removed by a dry etching process with the same plasma-enhanced etching apparatus, as shown in FIG. 2F. In this process, a gas containing F, for example CF₄, is used as the etching gas. In this case, Ti reacts with F to thereby generate volatile product or products and at the same time, Ti reacts with Si to thereby generate volatile product or products as well. Therefore, the SiO₂ layer 10 as the mask is etched back during the etching process for the TiN and Ti layers 6 and 5. Since the etch rate ratio of the Ti layer 5 and TiN layer 6 to the SiO₂ layer 10 is approximately (⅓) and therefore, the layer 10 with the remaining thickness of approximately 160 nm will be entirely removed while the TiN layer 6 with a thickness of 50 nm and the Ti layer 5 with a thickness of 20 nm are etched. The state at this stage is shown in FIG. 2G.

The etching gas and the etch rate ratio of the above-described dry etching processes for the layers 9, 8, 7, 6, and 5 are shown in Table 2 below.

TABLE 2

| | | ETCH-RATE RATIO |
|---|---|---|
| LAYER TO BE ETCHED | ETCHING GAS | TO SiO₂ |
| Ru layer 9 | Cl₂ + O₂ | 5 |
| (Upper Electrode) | | |
| PZT layer 8 | CF₄ + O₂ | 1 |
| (Dielectric) | | |
| Ru layer 7 | Cl₂ + O₂ | 5 |
| (Lower Electrode) | | |
| TiN layer 6 | CF₄ | ⅓ |
| Ti layer 5 | | |
| (Diffusion Barrier) | | |

In the dry etching process for the TiN and Ti layers 6 and 5, no volatile product is generated by the reaction of Ru and F. Thus, the etch-rate ratio of Ru to Ti or SiO₂ is sufficiently large, for example, 10 or higher. As a result, no bad effect will apply to the Ru layers 9 and 7 for the upper and lower capacitor electrodes and to the PZT layer 8 for the ferroelectric.

On the other hand, the etch-rate ratio of Ru to the interlayer dielectric layer 4 of SiO₂ is as low as approximately 3. Therefore, if the Ti layer 5 is overetched, there arises a disadvantage that the etching amount of the layer 4 increases. However, this disadvantage can be suppressed effectively by detecting correctly the endpoint of the etching process through monitoring the emission of light from Ti during the etching process. For example, the etching amount of the layer 4 can be suppressed to a sufficiently low level (i.e., to the etching thickness of 100 nm or less).

Through the above-described dry etching processes, as shown in FIG. 2G, a stacked structure 20 of the Ru layer 9, the PZT layer 8, the Ru layer 7, the TiN layer 6, and the Ti layer 5 is formed on the SiO₂ layer 4. The Ru layer 9, the PZT layer 8, and the Ru layer 7 constitute the desired capacitor element for the memory cell. At this stage, the patterned SiO₂ layer 10 serving as the hard mask is not left or the Ru layer 9, which is unlike the prior-art method described above.

Subsequently, as shown in FIG. 2H, a SiO₂ layer 11 (which serves as a cover layer of the capacitor element) is formed to cover the whole surface of the substrate 1. The thickness of the SiO₂ layer 11 is approximately 500 nm. This layer 11 is formed by the atmospheric-pressure CVD process using ozone (O₃) and tetraethoxysilane (TEOS) as the reaction gas.

The SiO₂ layer 11 (i.e., the cover layer) thus formed is selectively removed by a dry etching process, thereby forming a contact hole 12 penetrating vertically the layer 11, as shown in FIG. 2I. This dry etching process is carried out using CF₄ as the etching gas. The hole 12 exposes the Ru layer 9 for the upper electrode. Since the depth of the hole 12 is equal to the thickness of the layer 11, it is approximately 500 nm. This means that even if the diameter of the hole 12 is 0.4 μm, the aspect ratio of the hole 12 is limited or suppressed to approximately 1.25.

Finally, as shown in FIG. 2J, an Al layer 13 for wiring is formed on the SiO₂ layer 11 to contact the Ru layer 9 by way of the hole 12. The Al layer 23 is formed by the DC sputtering process that does not degrade the PZT layer 8. This is because the aspect ratio of the hole 12 is limited to approximately 1.25 and thus, the DC sputtering process that gives no bad effect to the PZT layer 8 can be used for this process. This is unlike the above-described prior-art method. Any other process may be applicable to this process if it gives no bad effect to the PZT layer 8.

With the method of forming a capacitor element according to the embodiment of the invention, as described above, the etching gas that contains fluorine (F) as one of its constituent elements is used in the dry etching process of selectively removing the TiN and Ti layers 6 and 5 serving as the barrier layers. The etching mask, i.e., the patterned SiO₂ layer 10, is finally etched back by the etching action in this process, thereby eliminating or removing the layer 10 entirely.

Accordingly, the aspect ratio of the contact hole 12 that exposes the upper capacitor electrode 9 can be decreased by the thickness of the remaining mask layer 10. Therefore, the wiring layer 13 can be formed by using a process (e.g., the DC sputtering process) having a less step coverage or less hole-filling property for the hole 12 and no capacitor-degradation property. In other words, a desired capacitor element can be formed by using a process (e.g., the DC sputtering process) having a less step coverage or less hole-filling property for the hole 12 and no capacitor-degradation property. This means that a fine capacitor element (e g., 1 μm or less in size) with the ferroelectric material (e.g., PZT) as the capacitor dielectric can be realized.

### VARIATIONS

Needless to say, the present invention is not limited to the above-described embodiment. Any change or modification may be added to the method of forming a capacitor element within the spirit of the invention.

For example, although a SiO₂ layer is used as the etching mask in the above-described embodiment , any other material (e.g., a TiN layer) may be used for this purpose. When a TiN layer is used as the etching mask layer, the contact hole 12 does not become as deep as the prior-art method even if the TiN layer is not removed. This is because TiN is a conductive material. However, it is popular that the capacitor element is subjected to a heat treatment process in an oxygen atmosphere to enhance the characteristics of the element. If the TiN layer is left on the upper electrode layer 9, the TiN layer tends to be oxidized and separated from the layer 9 during the heat treatment process. As a result, even if the TiN layer is used as the etching mask, it is effective or advantageous that the TiN layer is removed before the heat treatment process according to the method of the invention.

The etching mask may be formed by a layer of SiN, SiON, or TiO₂ or the like. In this case, the same advantages as those of the above-described embodiment are obtainable.

The TiN and Ti layers 6 and 5 are used for the barrier layers in the above-described embodiment. However, the invention is not limited to this. The material and structure of the barrier layer or layers may be optionally changed. For example, the barrier layer may be formed by a TaN layer alone.

In the above-described embodiment, each of the upper and lower electrode layers 9 and 7 is made of Ru. However, any other material than Ru may be used for this purpose. For example, each of the upper and lower electrode layers 9 and 7 is made of an oxide of Ru; Pt; Ir; or an oxide of Ir. Any other material may be used for these electrodes if the barrier layer or layers located below the lower electrode layer 7 is/are made of Ti-based material.

In the above-described embodiment, the feorroelectric layer 8 is made of PZT. However, the layer 8 may be made of any other ferroelectric material, such as SrBi₂Ta₂O₉ and (BaₓSr₁₋ₓ)TiO₃. In this case, the same advantages as the above-described embodiment are obtainable.

While the preferred forms of the present invention have been described, it is to be understood that modifications will be apparent to those skilled in the art without departing from the spirit of the invention. The scope of the present invention, therefore, is to be determined solely by the following claims.

What is claimed is:

1. A method of forming a capacitor element, comprising the steps:
(a) forming a barrier layer on a dielectric layer;
(b) forming a lower electrode layers a ferroelectric layer, and an upper electrode layer in this order on the barrier layer;
(c) forming an etching mask having a pattern for a desired capacitor element on the upper electrode layer;
(d) selectively removing the upper electrode layer by dry etching using the mask;
(e) selectively removing the ferroelectric layer by dry etching using the mask;
(f) a selectively removing the lower electrode layer by dry etching using the mask; and
(g) selectively removing the barrier layer by dry etching using the mask;
wherein an etching gas containing fluorine (F) as one of its constituent elements is used in the step (g);
and wherein the mask layer is etched back by an etching actions in the step (g), thereby eliminating or removing the mask layer.

2. The method according to claim 1, wherein the etching mask is made of one selected from the group consisting of SiO₂, SiO, SiN, SiON, TiN, and TiO₂.

3. The method according to claim 1, wherein the barrier layer is made of at least one selected from the group consisting of Ti, compounds of Ti, Ta, and compounds of Ta.

4. The method according to claim 1, wherein each of the lower electrode layer and the upper electrode layer contains at least one selected from the group consisting of Ru, RuO₂, Ir, IrO₂, Pt, and SrRuO₃.

5. The method according to claim 1, wherein the ferroelectric layer contains one selected from the group consisting of Pb (Zr₁₋ₓ,Tiₓ) O₃, SrBi₂Ta₂O₉, and (BaₓSr₁₋ₓ) TiO₃.

6. The method according to claim 1, wherein the etching gas used in the step (g) is one selected from the group consisting of CF₄, CHF₃, C₄F₉, and C₅F₉.

7. The method according to claim 1, wherein the dielectric layer located below the barrier layer comprises a conductive plug, the plug having a top end contacted with the barrier layer.
